(19) United States
(12) Patent Application Publication
(10) Pub. No.: US 2026/0187670 A1
(43) Pub. Date: Jul. 2, 2026

(54) IMAGE RECORDING APPARATUS, EXTERNAL TERMINAL AND SERVER

(71) Applicant: BROTHER KOGYO KABUSHIKI KAISHA, Nagoya (JP)

(72) Inventor: TAISEI OKUZONO, Nagoya (JP)

(73) Assignee: BROTHER KOGYO KABUSHIKI KAISHA, Nagoya (JP)

(21) Appl. No.: 19/426,683

(22) Filed: Dec. 19, 2025

(30) Foreign Application Priority Data
Dec. 26, 2024 (JP) 2024-230422

(51) Int. Cl. G06Q 30/0208; B41J 2/175; B41J 29/393; G06Q 10/30; G06Q 30/0207

(52) U.S. Cl. CPC G06Q 30/0208; B41J 2/17559; B41J 29/393; G06Q 10/30; G06Q 30/0239

(57) ABSTRACT

An image recording apparatus includes: a mounting part configured so that a consumable part is detachably mounted in the mounting part; a recording part configured to consume the consumable part mounted in the mounting part so as to record an image on a medium; and an apparatus controller. The apparatus controller is configured to cause the recording part to record an image indicating a pre-participation reward, as a reward which can be awarded to a user in accordance with the consumable part collected before the user participates in a reward-awarding service, the reward being awarded in accordance with collection of the consumable part in the reward-awarding service.

### REFERENCE TO RELATED APPLICATIONS

This application claims priority from Japanese Patent Application No. 2024-230422 filed on Dec. 26, 2024. The entire content of the priority application is incorporated herein by reference.

### BACKGROUND ART

The present disclosure relates to an image recording apparatus in which a consumable part is detachably mounted, an external terminal, and a server.

An ink-jet printer, which is an example of the known image recording apparatuses, consumes ink in an ink cartridge so as to record an image on a medium. In a case where a consumable part such as an ink cartridge is used up, the consumable part is collected, for example, by a collection company for recyclable products, such as the manufacturer of the ink-jet printer or the ink cartridge. Further, from the viewpoint of promoting the collection of the consumable part, a system, in which a reward is awarded to the user who cooperates in the collection, is provided.

For example, a system is known in which an incentive is awarded to a registered user, who has accessed a collection center system and registered as a registered user in advance, in a case where a consumable part consumed by the registered user is collected.

### SUMMARY

The user does not necessarily cause the consumable part to be collected after the user registration. In some cases, the user does not know that the reward is awarded for the collected consumable part(s) in a case where the user is registered as a registered user, and the user causes the consumable part to be collected, without the user registration. In the above-described example, the reward, including an incentive and a point, is not awarded for a consumable part collected before the user registers as the registered user. Therefore, the user might be dissatisfied since the user cannot receive the reward in accordance with the consumable part collected before the user registration.

The present disclosure aims to provide an image recording apparatus, an external terminal, and a server each of which is capable of reducing any dissatisfaction of the user regarding a consumable part collected before the user participates in a reward-awarding service.

An image recording apparatus according to an aspect of the present disclosure includes: a mounting part configured so that a consumable part is detachably mounted in the mounting part; a recording part configured to consume the consumable part mounted in the mounting part so as to record an image on a medium; and an apparatus controller. The apparatus controller is configured to cause the recording part to record an image indicating a pre-participation reward, as a reward which is awarded to a user in accordance with the consumable part collected before the user participates in a reward-awarding service, the reward being awarded in accordance with collection of the consumable part in the reward-awarding service.

An image recording apparatus according to another aspect of the present disclosure includes: a mounting part configured so that a consumable part is detachably mounted in the mounting part; a recording part configured to consume the consumable part mounted in the mounting part so as to record an image on a medium; and an apparatus controller. The apparatus controller is configured to generate recordable data of an image indicating a pre-participation reward, as a reward which is awarded to a user in accordance with the consumable part collected before the user participates in a reward-awarding service, the reward being awarded in accordance with collection of the consumable part in the reward-awarding service.

An external terminal according to an aspect of the present disclosure is an external terminal communicatively connected to a consuming apparatus configured so that a consumable part is detachably mounted in the consuming apparatus, the external terminal including a terminal controller. The terminal controller is configured to generate recordable data of an image indicating a pre-participation reward, as a reward which is awarded to a user, associated with the consuming apparatus, in accordance with the consumable part collected before the user participates in a reward-awarding service, the reward being awarded in accordance with collection of the consumable part in the reward-awarding service.

A server according to an aspect of the present disclosure is a server communicatively connected to a consuming apparatus configured so that a consumable part is detachably mounted in the consuming apparatus, the server including a server controller. The server controller is configured to generate recordable data of an image indicating a pre-participation reward, as a reward which is awarded to a user, associated with the consuming apparatus, in accordance with the consumable part collected before the user participates in a reward-awarding service, the reward being awarded in accordance with collection of the consumable part in the reward-awarding service.

According to the present disclosure, the user can be notified of the pre-participation reward. With this, the user can be prevented from being dissatisfied regarding the consumable part collected before the user participates in the reward-awarding service.

### BRIEF DESCRIPTION OF DRAWINGS

FIG. 1 depicts a schematic diagram of a system including a printer.

FIG. 2A depicts a view illustrating a participating user database. FIG. 2B is a view illustrating a non-participating user database. FIG. 2C is a view illustrating a collection database.

FIG. 3 depicts a flowchart illustrating a process regarding a cartridge list performed by a printer controller.

FIG. 4A and FIG. 4B depict a flowchart illustrating a process regarding a recycle point performed by a server controller.

FIG. 5 depicts a flowchart illustrating a process regarding recording of an image performed by the printer controller.

FIG. 6 depicts a schematic diagram of a sheet on which a test image and an image of registration guidance are recorded.

FIG. 7 depicts a flowchart illustrating a process regarding recording of the image of registration guidance performed by the printer controller of a printer.

FIG. 8 depicts a flowchart illustrating a process regarding recording of the image of registration guidance performed by the printer controller of a printer.

FIG. 9 depicts a vertical cross-sectional view illustrating an ink cartridge and a sub-tank in the printer.

### DESCRIPTION

### First Embodiment

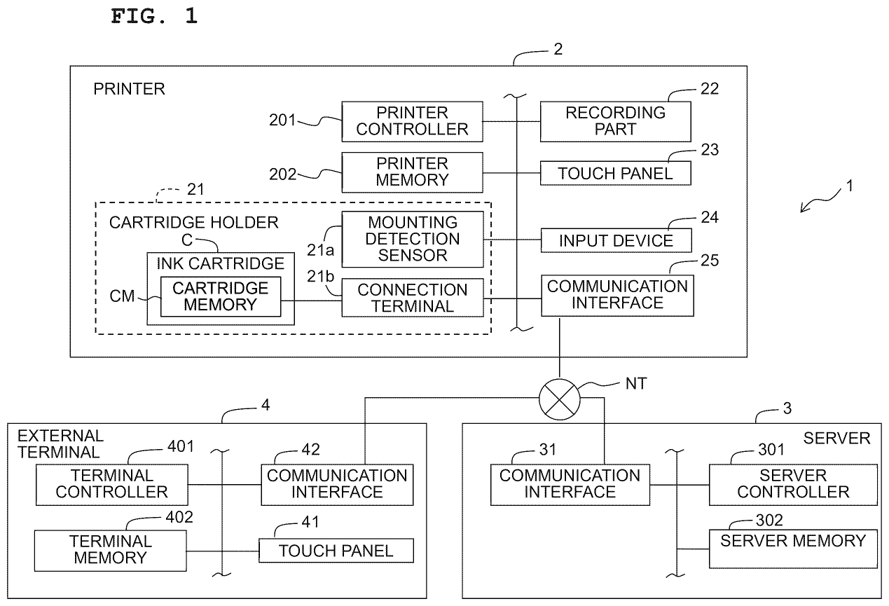

A printer 2 according to the first embodiment of the present disclosure constructs a system 1, together with a server 3 and an external terminal 4, as illustrated in FIG. 1.

The printer 2, the server 3, and the external terminal 4 are communicatively connected to one another via a network NT such as the Internet. The printer 2 and the external terminal 4 may be communicatively connected to each other via the server 3.

The term “communicatively connected” may encompass wired connection, such as connection via a USB cable, or wireless connection, such as connection via Wi-Fi (a registered trademark of Wi-Fi Alliance) or Bluetooth (a registered trademark of Bluetooth SIG, Inc.).

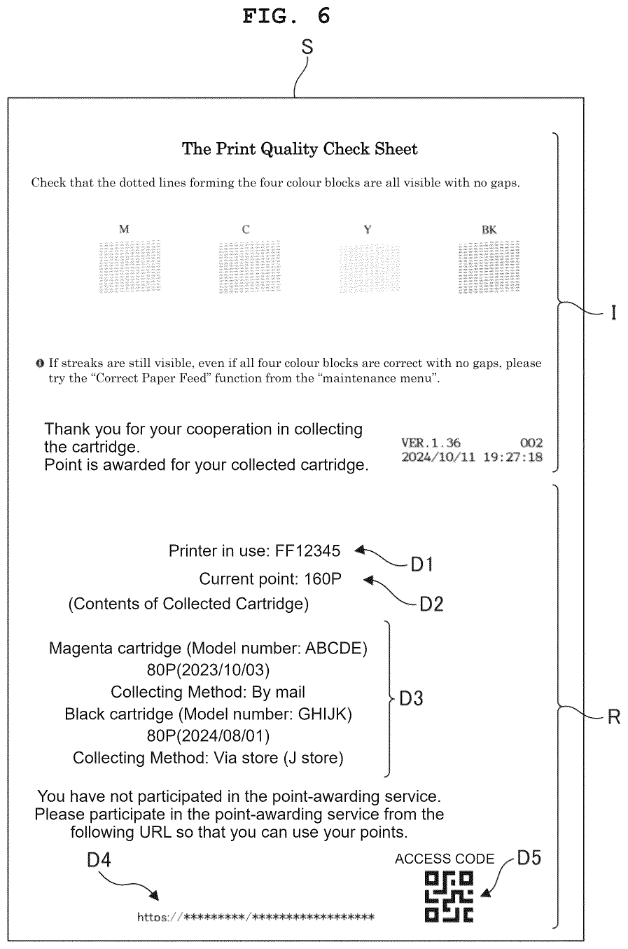

The printer 2 is an ink-jet printer, and includes a cartridge holder 21 configured so that an ink cartridge C is detachably mounted in the cartridge holder 21, and a recording part 22 which consumes ink in the ink cartridge C mounted in the cartridge holder 21 so as to record an image on a sheet S illustrated in FIG. 6. The printer 2 corresponds to an “image recording apparatus” of the present disclosure. The ink cartridge C corresponds to a “consumable part” of the present disclosure. The cartridge holder 21 corresponds to a “mounting part” of the present disclosure. The sheet S corresponds to a “medium” of the present disclosure.

The printer 2 further includes a touch panel 23, an input device 24, a communication interface 25, a printer controller 201, and a printer memory 202. The printer controller 201 corresponds to an “apparatus controller” of the present disclosure.

The ink cartridge C includes a casing capable of storing ink and a cartridge memory CM. The cartridge memory CM is a non-volatile memory and stores information unique to the ink cartridge C, such as a cartridge ID.

The touch panel 23 has a function of accepting input and a function of displaying, for example, a setting screen and an operating status. The input device 24 has a function of accepting input. The communication interface 25 is a network interface configured to communicate with other devices and is connected to the network NT.

The printer controller 201 is configured to control the operation of each of the parts or components of the printer 2 so as to control the operation of the printer 2, and includes a CPU, a ROM, and a RAM. The printer controller 201 performs various processes with the CPU in accordance with a program stored in the ROM and using data stored in the ROM and/or the RAM.

The printer memory 202 is a non-volatile memory, and stores a printer ID, which is information unique to the printer 2, and a cartridge list.

The cartridge holder 21 includes a mounting detection sensor 21a and a connection terminal 21b. The mounting detection sensor 21a outputs an ON signal in a case where an ink cartridge C is mounted in the cartridge holder 21, and outputs an OFF signal in a case where the ink cartridge C is not mounted in the cartridge holder 21. The connection terminal 21b is electrically connected to the cartridge memory CM in a case where the ink cartridge C is mounted in the cartridge holder 21. The printer controller 201 is capable of reading and writing data with respect to the cartridge memory CM via the connection terminal 21b.

The server 3 is a server installed and managed by the manufacturer of the printer 2 or other supplier, and includes a communication interface 31, a server controller 301, and a server memory 302. The communication interface 31 is a network interface similar to the communication interface 25.

The server controller 301 is configured to control the operation of each of parts or components of the server 3 so as to control the operation of the server 3, and includes a CPU, a ROM, and a RAM. The server controller 301 performs various processes with the CPU in accordance with a program stored in the ROM and using data stored in the ROM and/or the RAM.

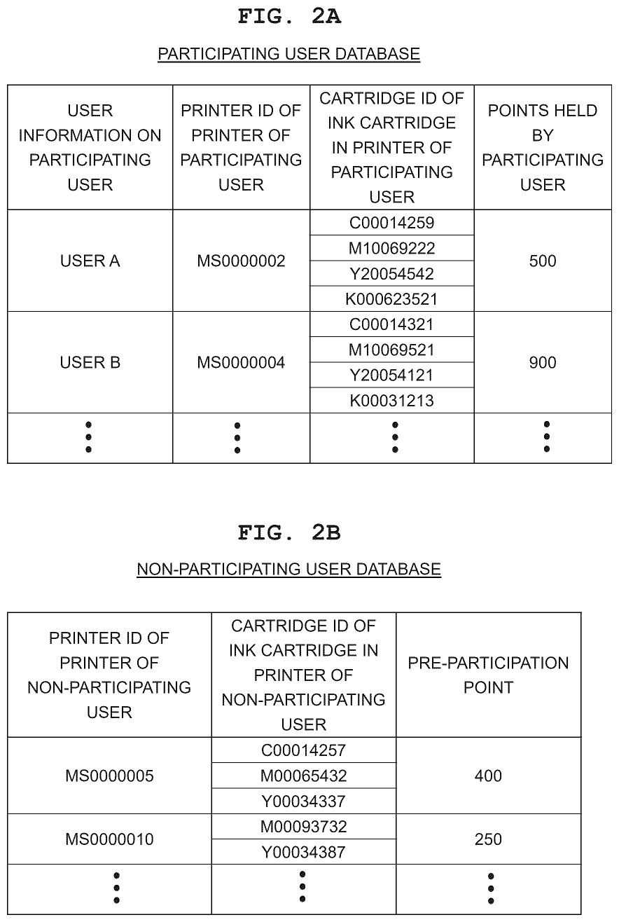

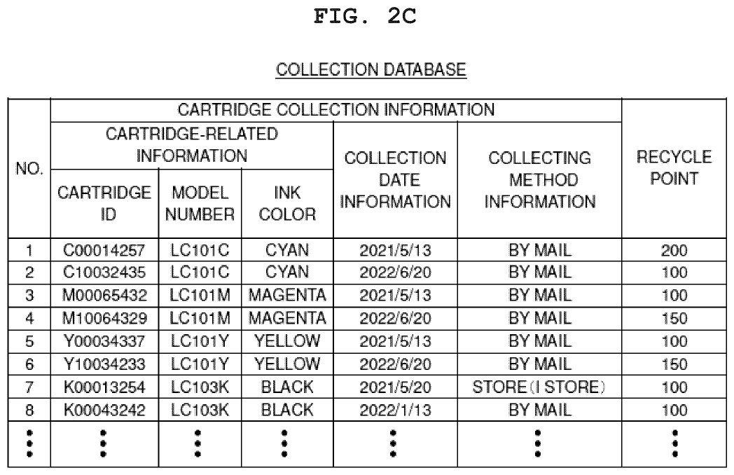

The server memory 302 is a non-volatile memory and stores a participating user database, a non-participating user database, and a collection database illustrated, respectively, in FIGS. 2A, 2B and 2C, as will be described later.

The external terminal 4 is a smartphone owned by a user of the printer 2, and is communicatively connected to the printer 2 and the server 3 wirelessly.

The external terminal 4 includes a touch panel 41, a communication interface 42, a terminal controller 401, and a terminal memory 402.

The touch panel 41 has a function similar to the function of the touch panel 23. The communication interface 42 is a network interface similar to the communication interface 25.

The terminal controller 401 is configured to control the operation of each of the parts or components of the external terminal 4 so as to control the operation of the external terminal 4, and includes a CPU, a ROM, and a RAM. The terminal controller 401 performs various processes with the CPU in accordance with a program stored in the ROM and using data stored in the ROM and/or the RAM.

The terminal memory 402 is a non-volatile memory and stores the printer ID and other information on the printer 2 owned by the user. For example, the terminal controller 401 wirelessly obtains the printer ID stored in the printer memory 202 via the communication interface 42 and stores the printer ID in the terminal memory 402.

Here, in a case where the recording part 22 performs recording, the ink inside the ink cartridge C, which is mounted in the cartridge holder 21, is consumed. In a case where the ink in the ink cartridge C runs out, the ink cartridge C mounted in the cartridge holder 21 needs to be replaced.

In recent years, from the viewpoint of environmental protection and ecology, a consumable part such as the ink cartridge C is desirably collected and recycled. The term “recycle, recycling” is a concept which encompasses recycling a used consumable part as a material or raw material, and remanufacturing the used consumable part.

The ink cartridge C is recycled, for example, as follows. The user sends the ink cartridge C, which has run out of the ink and is used up, to a collection company for recyclable products by mail or other means. The collection company for recyclable products performs a reprocessing process on the collected ink cartridge C. For example, the collector refills the collected ink cartridge C with the ink to make the collected ink cartridge C a recycled product which can be used again. The recycled ink cartridge C is delivered to the user via, for example, a store.

From the viewpoint of promoting the collection of the ink cartridge C, the system 1 provides a point-awarding service which awards a recycling point, as a reward, to a user who cooperates in the collection of the ink cartridge C. The point-awarding service corresponds to a “reward-awarding service” of the present disclosure. In the point-awarding service, in a case where a participating user, namely, a user who has participated in the service, has an ink cartridge C collected, a recycle point is awarded to the participating user. The recycle point is a point which can be returned to as a benefit in any form to the user, and can be used, for example, to purchase an ink cartridge C.

The server memory 302 stores the participating user database illustrated in FIG. 2A. In the participating user database, a user ID of the participating user, the printer ID of the printer 2 owned by the participating user, the cartridge ID of the ink cartridge C used in the printer 2 of the participating user, and points held by the participating user and indicating a total number of recycling points held by the user are associated with one another. The user ID is information unique to the user who owns the printer 2.

In a case where the ink cartridge C is collected, the collection company for recyclable products inputs cartridge collection information to the server 3. The cartridge collection information includes, for example, cartridge-related information, collection date information, and collecting method information, each on the collected ink cartridge C. The cartridge-related information includes the cartridge ID, the model number, and the ink color of the collected ink cartridge C. The collection date information indicates the date when the ink cartridge C has been collected. The collecting method information is information on a collecting method of the ink cartridge C, such as whether the ink cartridge has been sent to the collection company for recyclable products by mail, etc., or the ink cartridge C has been deposited in a collection box at a store.

The server controller 301 calculates the recycle point in accordance with the collection of the ink cartridge C based on the cartridge collection information.

In a case where the cartridge ID included in the cartridge collection information is registered in the participating user database, the server controller 301 determines that the participating user indicated by the user ID associated with the cartridge ID has caused the ink cartridge C, indicated by the cartridge ID, to be collected. Further, the server controller 301 adds, in the participating user database, the calculated recycle point to the point(s) held by the participating user associated with the cartridge ID. As a result, the participating user is awarded the recycle point in accordance with the collection of the ink cartridge C. In a case where the participating user uses the recycle point, the server controller 301 subtracts the amount corresponding to the used recycle point from the held points associated with the user ID of the participating user, in the participating user database.

Owing to the above-described configuration, the recycle point is awarded to the user, in accordance with the collection of the ink cartridge C, so that the awareness of the participating user to cause the ink cartridge to be collected can be raised.

Further, in order to avoid such a situation that the user is dissatisfied with respect to the ink cartridge C collected before the user participates in the point-awarding service, the system 1 is configured to be capable of retroactively awarding the recycling point to the participating user in accordance with the ink cartridge C collected before the user participates in the point-awarding service. In the following, this system will be specifically described.

The server memory 302 stores the non-participating user database illustrated in FIG. 2B and the collection database illustrated in FIG. 2C, in addition to the participating user database illustrated in FIG. 2A.

The non-participating user database is a database regarding non-participating users who are each a user not participated in the point-awarding service. In the non-participating user database, the printer ID of a printer 2 owned by each non-participating user, of the non-participating users, the cartridge ID of an ink cartridge C used in the printer 2 of the non-participating user, and a pre-participation point, which indicates the total number of a recycling point to be retroactively awarded to the non-participating user in a case where the non-participating user participates in the point-awarding service are associated with one another. The pre-participation point corresponds to “pre-participation reward” of the present disclosure.

The collection database is a database regarding the ink cartridges C which the non-participating users have had collected. In a case where the cartridge ID included in the cartridge collection information obtained from the collection company for recyclable products is not registered in the participating user database, the server controller 301 associates the cartridge collection information with the calculated recycle point and registers the cartridge collection information and the calculated recycle point, in the collection database.

In a case where the ink cartridge C is mounted in the cartridge holder 21, the printer controller 201 reads the cartridge ID from the cartridge memory CM of the ink cartridge C and registers the cartridge ID in the cartridge list in the printer memory 202. The cartridge list is a list indicating the cartridge ID of each of the ink cartridges C mounted in the cartridge holder 21.

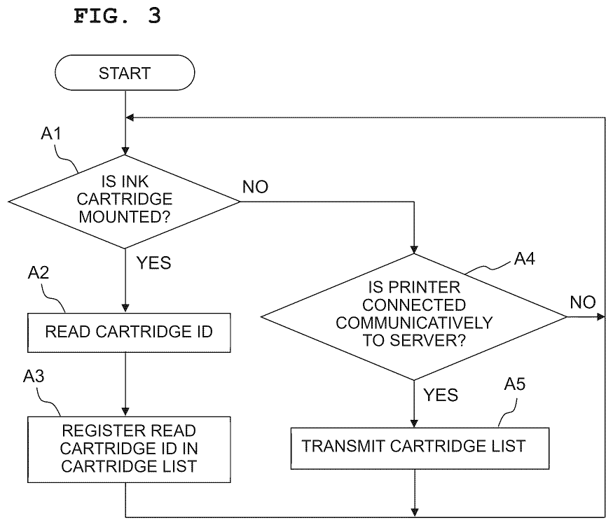

Specifically, as illustrated in FIG. 3, the printer controller 201 determines whether an ink cartridge C is newly mounted in the cartridge holder 21, based on the signal from the mounting detection sensor 21a (step A1). In step A1, the printer controller 201 determines whether the state of the cartridge holder 21 is transitioned from a state where the ink cartridge C is not mounted in the cartridge holder 21 to a state where the ink cartridge C is mounted in the cartridge holder 21.

In a case where the printer controller 201 determines that an ink cartridge C is newly mounted (step A1: YES), the printer controller 201 reads the cartridge ID stored in the cartridge memory CM of the ink cartridge C, via the connection terminal 21b (step A2). After step A2, the printer controller 201 registers the read cartridge ID in the cartridge list of the printer memory 202 (step A3). After step A3, the printer controller 201 returns to step A1.

In a case where the printer controller 201 determines that ink cartridge C is not newly mounted (step A1: NO), the printer controller 201 determines whether the printer 2 is communicatively connected to the server 3 (step A4). In a case where the printer controller 201 determines that the printer 2 is not communicatively connected to the server 3 (step A4: NO), the printer controller 201 returns to step A1. In a case where the printer controller 201 determines that the printer 2 is communicatively connected to the server 3 (step A4: YES), the printer controller 201 transmits the printer ID and the cartridge list stored in the printer memory 202 to the server 3 (step A5). After step A5, the printer controller 201 returns to step A1. In a case where the cartridge list has not been updated since the process of step A5 has been performed the last time, the printer controller 201 may omit the process of step A5.

In a case where the server controller 301 determines that the obtained printer ID is registered in the participating user database, the server controller 301 associates the cartridge ID in the obtained cartridge list with the registered printer ID, and registers the cartridge ID in the participating user database. In a case where the server controller 301 determines that the obtained printer ID is not registered in the participating user database, the server controller 301 associates the cartridge ID in the obtained cartridge list with the obtained printer ID and registers the cartridge ID and the printer ID, in the non-participating user database.

In a case where the cartridge ID in the obtained cartridge list matches any one of the cartridge IDs in the cartridge collection information in the collection database, the server controller 301 further determines that the ink cartridge C indicated by the matched cartridge ID is an ink cartridge C which a non-participating user, who owns the printer 2 indicated by the obtained printer ID, has caused to be collected in the past. In this case, the server controller 301 calculates the total amount of the recycle point associated with the matched cartridge ID in the collection database. Then, the server controller 301 associates the calculated total amount of the recycled point with the printer ID of the printer 2 of the non-participating user, and registers the calculated total amount of the recycle point as a pre-participation point in the non-participating user database.

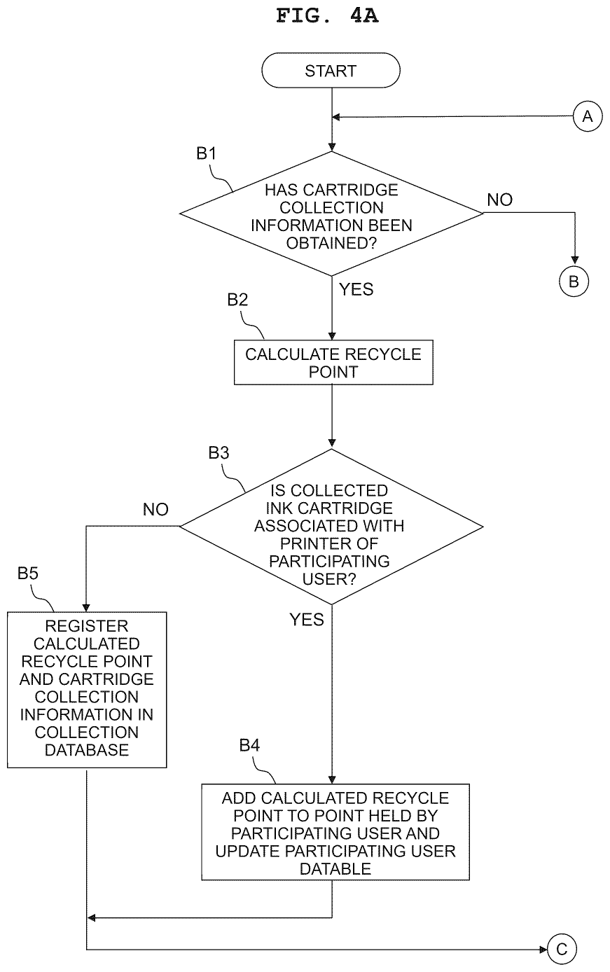

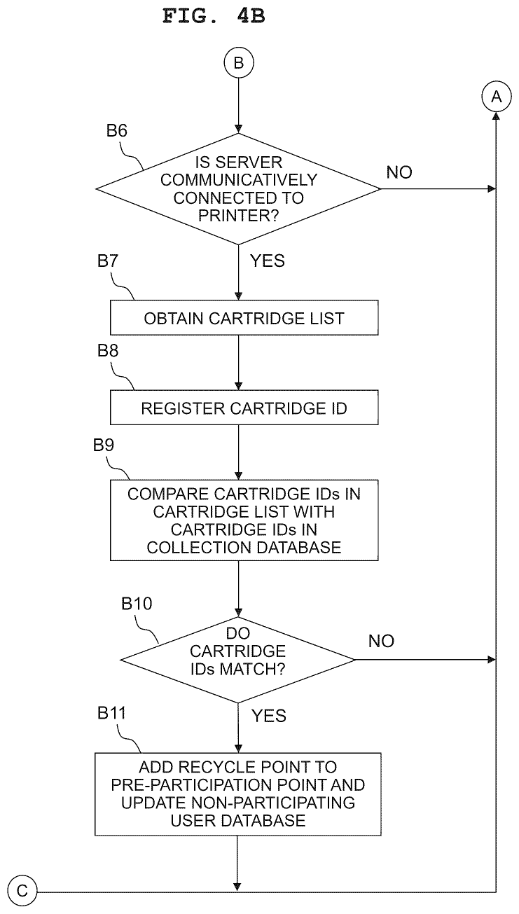

Specifically, as illustrated in FIG. 4, the server controller 301 first determines whether the cartridge collection information has been obtained from the collection company for recyclable products (step B1). In a case where the server controller 301 determines that the cartridge collection information has been obtained (step B1: YES), the server controller 301 calculates the recycle point based on the obtained cartridge collection information (step B2).

After step B2, the server controller 301 refers to the participating user database stored in the server memory 302 to determine whether the cartridge ID included in the cartridge collection information is associated with the printer ID of the printer 2 of the participating user (step B3).

In a case where the server controller 301 determines that the cartridge ID is associated with the printer ID of the printer 2 of one of the participating users (step B3: YES), the server controller 301 adds the recycle point calculated in step B2 to the point(s) which is held by the participating user in the participating user database in the server memory 302 (step B4), and returns to step B1.

In a case where the server controller 301 determines that the cartridge ID is not associated with the printer ID of the printer 2 of any one of the participating users (step B3: NO), the server controller 301 associates the obtained cartridge collection information with the recycle point calculated in step B2, registers the obtained cartridge collection information and the calculated recycle point, in the collection database stored in the server memory 302 (step B5), and returns to step B1.

In a case where the server controller 301 determines that cartridge collection information has not been obtained (step B1: NO), the server controller 301 determines whether the server 3 is communicatively connected to the printer 2 (step B6). In a case where the server controller 301 determines that the server 3 is not communicatively connected to the printer 2 (step B6: NO), the server controller 301 returns to step B1.

In a case where the server controller 301 determines that the server 3 is communicatively connected to the printer 2 (step B6: YES), the server controller 301 obtains the printer ID and the cartridge list from the printer 2 (step B7). After step B7, the server controller 301 registers the cartridge ID in the obtained cartridge list in the participating user database or in the non-participating user database (step B8). Specifically, in a case where the obtained printer ID is registered in the participating user database, the server controller 301 associates the cartridge ID in the obtained cartridge list with the printer ID of the printer 2 from which the cartridge ID in the obtained cartridge list has been obtained, and registers the cartridge ID in the obtained cartridge list, in the participating user database. On the other hand, in a case where the obtained printer ID is not registered in the participating user database, the server controller 301 associates the cartridge ID in the obtained cartridge list with the obtained printer ID of the printer 2 from which the cartridge ID in the obtained cartridge list has been obtained, and registers the cartridge ID and the obtained printer ID in the obtained cartridge list, in the non-participating user database.

After step B8, the server controller 301 compares each of the cartridge IDs in the obtained cartridge list with each of the cartridge IDs in the collection database stored in the server memory 302 (step B9). After step B9, in a case where the server controller 301 determines that none of the cartridge IDs in the cartridge list match any of the cartridge IDs in the collection database (step B10: NO), the server controller 301 returns to step B1.

In a case where the server controller 301 determines that any of the cartridge IDs in the cartridge list matches one of the cartridge IDs in the collection database (step B10: YES), the server controller 301 updates the non-participating user database stored in the server memory 302 (step B11). Specifically, the server controller 301 adds the recycle point to the pre-participation point(s) associated with the printer ID obtained in step B7, in the non-participating user database. The addition of the recycled point composes the total value of the recycled points associated with each of the cartridge IDs matching a corresponding one of the cartridge IDs in the cartridge list in the collection database. After step B11, the server control 301 returns to step B1.

Owing to the above-described configuration, the pre-participation point, as the reward which can be awarded to the user in accordance with the ink cartridge C collected before the user participates in the point-awarding service can be stored in the server memory 301.

After the user has participated in the point-awarding service, the server controller 301 updates the database stored in the server memory 302. Specifically, the server controller 301 newly registers, in the participating user database, the user ID of the user who has participated in the point-awarding service, the printer ID of the printer 2 owned by the user who has participated in the point-awarding service, and the cartridge ID which has been associated with the printer ID in the non-participating user database. Further, the server controller 301 associates the pre-participation point(s), which has been associated with the printer ID of the printer 2 of the user in the non-participating user database, with the printer ID of printer 2 of the user who has now participated in the point-awarding service, as the point(s) held by the user, and registers the held point(s) in the participating user database. Furthermore, the server controller 301 deletes, from the non-participating database, the cartridge ID and the recycle points held by the user, each of which has been associated with the printer ID of the printer 2 of the user who has now participated in the point-awarding service. Moreover, the server controller 301 deletes, from the collection database, the cartridge collection information and the recycle point each of which is associated with the cartridge ID of the ink cartridge C of the user who has now participated in the point-awarding service.

The printer 2 causes the recording part 22 to record an image including the pre-participation point(s), which is an image regarding registration guidance for the point-awarding service, in the following manner.

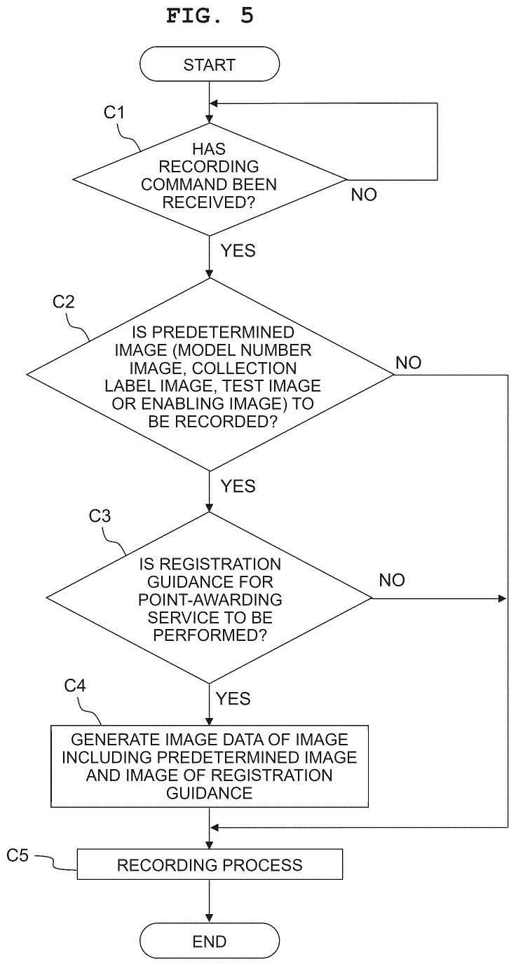

Specifically, as illustrated in FIG. 5, the printer controller 201 first determines whether a recording command has been received (step C1). The recording command is transmitted to the printer 2 from the external terminal 4 or is input to the printer 2 via the input device 24. In a case where the printer controller 201 determines that the recording command has not been received (step C1: NO), the printer controller 201 returns to step C1.

In a case where the printer controller 201 determines that the recording command has been received (step C1: YES), the printer controller 201 determines whether the recording command is a command to record a predetermined image (step C2).

The predetermined image corresponds to a “recording image” of the present disclosure, and includes a model number image, a collection label image, a test image, and an enabling image. The model number image is an image indicating the model number of the ink cartridge C mounted in the cartridge holder 21, and corresponds to an “image indicating information on the consumable part” of the present disclosure. The collection label image is an image recorded on a label which is to accompany the ink cartridge C in a case where the ink cartridge C is collected, and corresponds to an “image to accompany the consumable part in a case where the consumable part is collected” of the present disclosure. For example, the user reads, with the external terminal 4, a two-dimensional code for recording the collection label image which is printed on the package of ink cartridge C, and causes the external terminal 4 to transmit, to the printer 2, a recording command to record the collection label. The test image is an image with which the recording by the recording part 22 is confirmed. The enabling image is an image for enabling a function provided by the server 3. The function may be, for example, a function of imparting a dedicated e-mail address. For example, to prevent unauthorized use of the function, the enabling image is to be recorded in the printer 2, which is communicatively connected to the server 3, so as to enable the function.

In a case where the printer controller 201 determines that the recording command is the command to record the predetermined image (step C2: YES), the printer controller 201 determines whether registration guidance for the point-awarding service is to be performed (step C3).

In step C3, the printer controller 201 queries the server 3 as to whether the pre-participation point associated with a certain printer ID satisfies a predetermined condition. In a case where the printer controller 201 receives, from the server 3, a response indicating that the pre-participation point satisfies the predetermined condition, the printer controller 201 determines that the registration guidance for the point-awarding service is to be performed. In this situation, the server 3 transmits, to the printer 2, information on the registration guidance, which includes the pre-participation point, together with the above-described response. On the other hand, in a case where the printer controller 201 receives, from the server 3, a response indicating that the pre-participation point does not satisfy the predetermined condition, the printer controller 201 determines that the registration guidance for the point-awarding service is not to be performed. The predetermined condition may be, for example, a condition that the pre-participation point is a threshold value or more. The threshold value may be, for example, 500 points.

In a case where the printer controller 201 determines that the registration guidance for the point-awarding service is to be performed (step C3: YES), the printer controller 201 generates image data of an image including the predetermined image and an image of the registration guidance (step C4), based on the image data included in the recording command and the information on the registration guidance received from the server 3 in step C3. The image data is RGB (red, green, blue) data corresponding to the colors of an image which is recordable by the recording part 22.

After step C4, the printer controller 201 performs a recording process (step C5). In a case where the printer controller 201 determines that the recording command is not the command to record the predetermined image (step C2: NO), and in a case where the printer controller 201 determines that the registration guidance for the point-awarding service is not to be performed (step C3: NO), the printer controller 201 also performs the recording process (step C5). The recording process is a process of causing the recording part 22 to record an image based on the image data. After step C5, the printer controller 201 ends the program.

In a case where the printer controller 201 determines that the recording command is not the command to record the predetermined image (step C2: NO), the printer controller 201 causes the recording part 22 to record the image in accordance with the recording command based on the image data included in the recording command, in step C5.

In a case where the printer controller 201 determines that the registration guidance for the point-awarding service is not to be performed (step C3: NO), the printer controller 201 causes the recording part 22 to record the predetermined image based on the image data included in the recording command in step C5.

In step C5 after step C4, the printer controller 201 causes the recording part 22 to record a predetermined image I and the image of the registration guidance based on the image data generated in step C4. In FIG. 6, the predetermined image I is the test image. The image of the registration guidance is recorded in a margin area R, which is an area, of the sheet S, other than a recording area of the predetermined image I, as illustrated in FIG. 6.

The image of the registration guidance includes the printer ID (D1) of the printer 2 used by the user, the pre-participation point (D2), information (D3) on an ink cartridge C collected before participating in the point-awarding service, and information (D4, D5) for participating in the point-awarding service. The information (D3) includes, for example, the color, the model number, the recycle point in accordance with the collection of the ink cartridge C, the date of awarding the recycle point, the collecting method, etc. The color is the color of the ink stored in the ink cartridge C, such as magenta, black, etc. The color and the model number correspond to “information on the consumable part” in the present disclosure. The information for participating in the point-awarding service includes a URL (D4) for participating in the point-awarding service and a two-dimensional code (D5) indicating the URL.

In a case where a plurality of ink cartridges C collected before participating in the point-awarding service exits, the information (D3) on the ink cartridges C, such as the color, the model number, the recycling point, and the date of awarding the recycling point, is recorded separately for each of the plurality of ink cartridges C.

In such a manner, the printer controller 201 causes the recording part 22 to record the image which includes the pre-participation point and which is the image regarding the registration guidance for the point-awarding service, before the user participates in the point-awarding service.

Further, even after the user has participated in the point-awarding service, the printer controller 201 causes the recording part 22 to record the image indicating the pre-participation point in response to input from the participating user. The image may be, for example, an image which is similar to the image of the registration guidance as illustrated in FIG. 6, except that the information (D4, D5) for participating in the point-awarding service is omitted.

As described above, according to the present embodiment, the printer controller 201 causes the recording part 22 to record the image as illustrated in FIG. 6 which indicates the pre-participation points (D2) as the reward which can be awarded (to the user) in accordance with the ink cartridge C collected before the user participates in the point-awarding service. With this, the user can be notified of the pre-participation point. Consequently, the user can be prevented from being dissatisfied regarding the ink cartridge C collected before the user participates in the point-awarding service.

The printer controller 201 causes the recording part 22 to record the image indicating the pre-participation point (D2) before the user participates in the point-awarding service. In this case, since the non-participating user knows the pre-participation point, the non-participating user is more likely to be motivated to participate in the point-awarding service.

Before the user participates in the point-awarding service, the printer controller 201 causes the recording part 22 to record, as information for participating in the point-awarding service, the image indicating the URL for participating in the point-awarding service (D4) and the two-dimensional code (D5) indicating the URL, together with the image indicating the pre-participation point (D2), as illustrated in FIG. 6. In this case, the user can be encouraged to participate in the point-awarding service.

The information for participating in the point-awarding service includes the two-dimensional code (D5) indicating the URL, as illustrated in FIG. 6. In this case, the user can easily participate in the point-awarding service by reading the two-dimensional code with the smartphone which is the external terminal 4.

The printer controller 201 causes the recording part 22 to record the image indicating the pre-participation point (D2) after the user has participated in the point-awarding service. In this case, the user, who now knows the pre-participation point, may consider the point-awarding service favorably.

As illustrated in FIG. 6, the printer controller 201 causes the recording part 22 to record the image indicating the date (D3) on which the user has been awarded the recycle point (D4) in accordance with the ink cartridge C collected before participating in the point-awarding service, together with the image indicating the pre-participation point (D2). In this case, the user is more likely to be motivated to cause the ink cartridge C to be collected and to participate in the point-awarding service.

As illustrated in FIG. 6, the printer controller 201 causes the recording part 22 to record the image indicating the color and the model number (D3) of the ink cartridge C collected before participating in the point-awarding service, together with the image indicating the pre-participation point (D2). In this case, the user is more likely to be motivated to cause the ink cartridge C to be collected and to participate in the point-awarding service.

As illustrated in FIG. 6, the printer controller 201 causes the recording part 22 to record the image indicating the collecting method (D3) of the ink cartridge C collected before participating in the point-awarding service, together with the image indicating the pre-participation point (D2). In this case, the user is easily motivated to cause the ink cartridge C to be collected and to participate in the point-awarding service.

In a case where a plurality of ink cartridges C exists, collected before participating in the point-awarding service, the printer controller 201 causes the recording part 22 to record the image indicating the recycling point (D3) for each of the plurality of ink cartridges C individually, together with the image indicating the pre-participation point (D2), as illustrated in FIG. 6. With this, the user is easily motivated to cause the ink cartridges C to be collected and to participate in the point-awarding service.

As illustrated in FIG. 6, the printer controller 201 causes the recording part 22 to record the image indicating the pre-participation point in the margin area R, which is the area other than the recording area of the predetermined image I in the sheet S, while causing the printing part 22 to perform the recording process (step C5). In this case, the user can easily recognize the pre-participation point, together with the predetermined image I, on a single sheet S. Further, since the image indicating the pre-participation point is recorded in the margin area R, the sheet S is not wasted, without disadvantage to the user, as compared to a case where the sheet S is used solely for recording the image indicating the pre-participation point.

The predetermined image I includes the model number image which is the image indicating the model number of the ink cartridge C mounted in the cartridge holder 21. In a case where the user replaces the ink cartridge C, the user causes the recording part 22 to record the model number image in order to know the information on the ink cartridge C, in some cases. The user, upon recognizing the pre-participation point at this time, is easily motivated to cause the ink cartridge C to be collected and to participate in the point-rewarding service.

The predetermined image I includes the collection label image, as the image which is to accompany the ink cartridge C in a case where the ink cartridge C is collected. In a case where the user replaces the ink cartridge C, the user causes the recording part 22 to record the collection label image, in some cases. The user, upon recognizing the pre-participation point at this time, is more likely to be motivated to cause the ink cartridge C to be collected and to participate in the point-awarding service.

The predetermined image I includes the test image. In many cases, the sheet S on which the test image is recorded is no longer needed after the test image has been confirmed. As illustrated in FIG. 6, since the image indicating the pre-participation point (D2) is recorded in the margin area R of such a sheet S, the sheet S is not wasted, without disadvantage to the user. Further, the test image is more likely to be recorded in a case where the ink cartridge C is to be replaced. The user, upon recognizing the pre-participation point at this time, is more likely to be motivated to cause the ink cartridge C to be collected and to participate in the point-awarding service.

The predetermined image I includes the enabling image. In many cases, the sheet S on which the enabling image is recorded is no longer needed after the function is enabled. Since the image indicating the pre-participation point (D2) is recorded in the margin area R of such a sheet S, the sheet S is not wasted, without disadvantage to the user. Further, the recording of the enabling image is likely to be performed at a timing at which the user is interested in the service provided by the server. The user, upon recognizing the pre-participation point at this time, is more likely to be motivated to participate in the point-rewarding service.

Notification of the pre-participation point to the user having the pre-participation point not satisfying the predetermined condition, e.g., the pre-participation point less than the threshold value, is of little merit to the user, and the user might find such notification bothersome. Further, with respect to the printer 2 also, recording the image indicating the pre-participation point even for a user having the pre-participation point not satisfying the predetermined condition might result in wasting the ink and the sheet S. In view of the above-described situation, the printer controller 201 of the present embodiment causes the recording part 22 to record the image indicating the pre-participation point in a case where the pre-participation point satisfies the predetermined condition. With this, the user is prevented from feeling bothersome, and the ink and the sheet S are prevented from being wasted.

### Second Embodiment

The printer 2 of the first embodiment is communicatively connected to the server 3 at all times, whereas the printer 2 of the second embodiment is not communicatively connected to the server 3 at all times. The printer controller 201 of the second embodiment is not triggered in response to the receipt of the recording command to record the predetermined image I, but is triggered in response to the printer being communicatively connected to the server 3, so as to cause the recording part 22 to record the image indicating the pre-participation point.

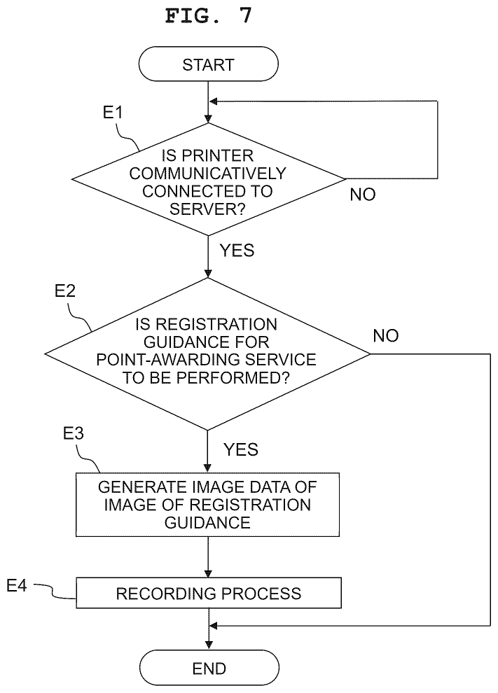

Specifically, in the second embodiment, the printer controller 201 first determines whether the printer 2 is communicatively connected to the server 3 (step E1), as illustrated in FIG. 7. In a case where the printer controller 201 determines that the printer 2 is not communicatively connected to the server 3 (step E1: NO), the printer controller 201 returns to step E1.

In a case where the printer controller 201 determines that the printer 2 is communicatively connected to the server 3 (step E1: YES), the printer controller 201 determines whether the registration guidance for the point-awarding service is to be performed. (step E2).

In step E2, similarly to the process in step C3, the printer controller 201 queries the server 3 as to whether the pre-participation point associated with a certain printer ID satisfies a predetermined condition. Further, in a case where the printer controller 201 receives, from the server 3, a response indicating that the pre-participation point satisfies the predetermined condition, the printer controller 201 determines that the registration guidance for the point-awarding service is to be performed. In this situation, the server 3 transmits, to the printer 2, information on the registration guidance, which includes the pre-participation point, together with the above-described response. On the other hand, in a case where the printer controller 201 receives, from the server 3, a response indicating that the pre-participation point does not satisfy the predetermined condition, the printer controller 201 determines that the registration guidance for the point-awarding service is not to be performed. The predetermined condition may be, for example, a condition that the pre-participation point is a threshold value or more. The threshold value may be, for example, 500 points.

In a case where the printer controller 201 determines that the registration guidance for the point-awarding service is to be performed (step E2: YES), the printer controller 201 generates image data of an image of the registration guidance, based on the information on the registration guidance received from the server 3 in step E2 (step E3). The image data is RGB (red, green, blue) data corresponding to the colors of an image which is recordable by the recording part 22.

After step E3, the printer controller 201 performs the recording process (step E4). In step E4, the printer controller 201 causes the recording part 22 to record the image of the registration guidance based on the image data generated in step E3. The image of the registration guidance is, for example, only an image, among the images illustrated in FIG. 6, recorded in a margin area R.

After step E4, or in a case where the printer controller 201 determines that the registration guidance for the point-awarding service is not to be performed (step E2: NO), the printer controller 201 ends the program.

As described above, according to the second embodiment, even in a case where the printer 2 is not communicatively connected to the server 3 at all times, the printer controller 201 is capable of obtaining the information indicating the pre-participation point from the server 3 at a timing at which the printer 2 is connected to the server 3, and the printer controller 201 is capable of causing the recording part 22 to record the image indicating the pre-participation point.

### Third Embodiment

The printer controller 201 of the third embodiment is not triggered in response to the receipt of the recording command to record the predetermined image I, but is triggered in response to the ink cartridge C being detached, so as to cause the recording part 22 to record the image indicating the pre-participation point.

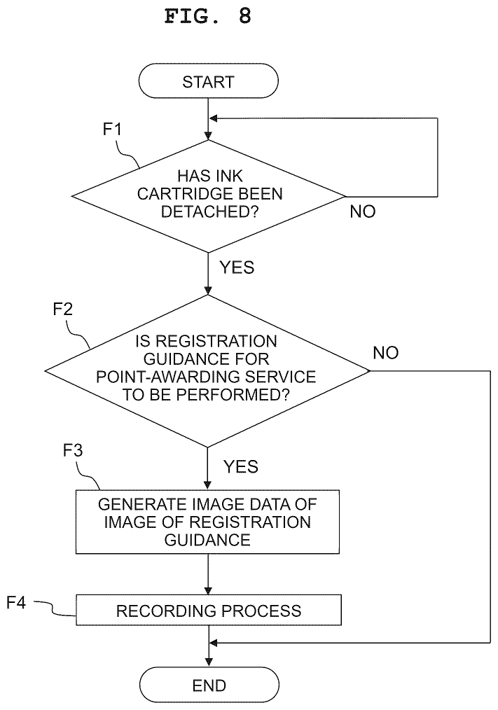

Specifically, in the third embodiment, as illustrated in FIG. 8, the printer controller 201 first determines whether the ink cartridge C has been detached from the cartridge holder 21, based on the signal from the mounting detection sensor 21a (step F1). In a case where the printer controller 201 determines that the ink cartridge C has not been detached from the cartridge holder 21 (step F1: NO), the printer controller 201 returns to step F1.

In a case where the printer controller 201 determines that the ink cartridge C has been detached from the cartridge holder 21 (step F1: YES), the printer controller 201 determines whether the registration guidance for the point-awarding service is to be performed (step F2). The process in step F2 and the processes thereafter are the same as the process in step E2 and the processes thereafter in the second embodiment illustrated in FIG. 7.

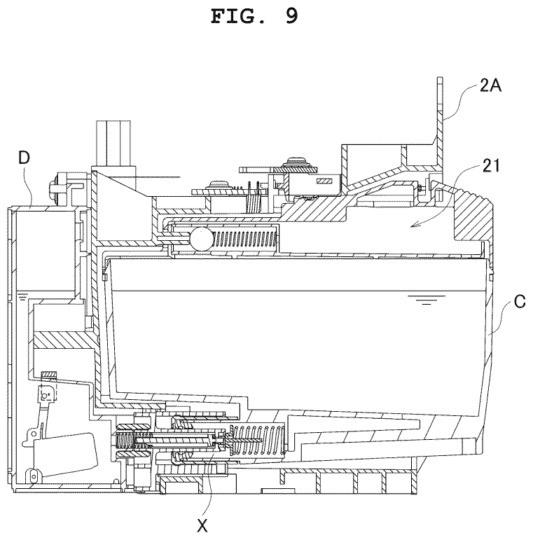

Note that, as illustrated in FIG. 9, the printer 2 of the third embodiment includes a sub-tank D as a tank configured to store ink, in addition to the ink cartridge C. While the ink cartridge C is detachably mounted in the casing 2A of the printer 2, the sub-tank D is not detachable from the casing 2A. The ink corresponds to a “recording material” of the present disclosure, and the ink cartridge C corresponds to a “main tank” of the present disclosure. The sub-tank D communicates with the ink cartridge C mounted in the cartridge holder 21 via a communication path X, and stores the ink supplied from the ink cartridge C.

As described above, according to the third embodiment, the user, upon recognizing the pre-participation point at the timing at which the user detaches the ink cartridge C, is easily motivated to cause the ink cartridge C to be collected and to participate in the point-awarding service.

The printer 2 includes, as the tank configured to store the ink, the sub-tank D illustrated in FIG. 9, in addition to the ink cartridge C. In this situation, in a case where the ink cartridge C is detached, the ink in sub-tank D can be used to record the image indicating the pre-participation point.

### Fourth Embodiment

In the first embodiment, the pre-participation point is provided as the pre-participation reward. In contrast, in the fourth embodiment, a discount reward which is obtainable in a case where the user participates in the point-awarding service and uses the point is provided as the pre-participation reward. The discount reward corresponds to a “benefit” of the present disclosure.

According to the fourth embodiment, the user is likely to be motivated to participate in the point-awarding service.

### Fifth Embodiment

The printer controller 201 of the first embodiment generates the image data indicating the pre-participation point (step C4) and further performs the recording process (step C5) based on the image data. In contrast, the printer controller 201 of the fifth embodiment generates the image data indicating the pre-participation point (step C4), but does not perform the recording process (step C5) based on the image data.

The image data generated by the printer controller 201 of the fifth embodiment may be transmitted to any printer. The printer which has received the image data may cause the recording part of the printer to record an image on a sheet S, based on the image data. The above-described printer may be a printer owned by the manufacturer or other vendor which manages the server 3.

As described above, according to the fifth embodiment, the printer controller 201 generates recordable data of the image, as illustrated in FIG. 6, indicating the pre-participation point (D2) as the reward which can be awarded with respect to the ink cartridge C which the user collected before the user participates in the point-awarding service, although the print controller 201 does not perform the recording process of recording the above-described image. In this case, the printer controller 201 causes any printer to perform the printing process by using the above-described image data so that the user can be notified of the pre-participation point, and, consequently, so that the user can be prevented from being dissatisfied regarding the ink cartridge C collected before the user participates in the point-awarding service.

### Sixth Embodiment

In the first embodiment, the printer controller 201 generates the image data indicating the pre-participation points. In contrast, in the sixth embodiment, the server controller 301 or the terminal controller 401 generates the image data indicating the pre-participation point. The terminal controller 401 may obtain information on the pre-participation point stored in the server memory 302 and may generate the image data. In the sixth embodiment, the printer 2 corresponds to a “consuming apparatus” of the present disclosure.

The image data generated by the server controller 301 or the terminal controller 401 of the sixth embodiment may be transmitted to any printer. The printer which has received the image data may cause the recording part of the printer to record an image on a sheet S, based on the image data. The above-described printer may be a printer owned by the manufacturer or other vendor which manages the server 3, or may be a printer 2 owned by the user.

As described above, according to the sixth embodiment, the server controller 301 or the terminal controller 401 generates recordable data of the image, as illustrated in FIG. 6, indicating the pre-participation point (D2) as the reward which can be awarded with respect to the ink cartridge C collected before the user participates in the point-awarding service. In this case, the server controller 301 or the terminal controller 401 causes any printer to perform the printing process by using the above-described image data so that the user can be notified of the pre-participation point, and, consequently, so that the user can be prevented from being dissatisfied regarding the ink cartridge C collected before the user participates in the point-awarding service.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modifications

The apparatus controller of the apparatus (the printer 2, the server 3, or the external terminal 4) may, for example, periodically obtain, from the server, information on a consumable part mounted in the apparatus, the information being included in the information on the collection of the consumable part stored in the apparatus memory, such as the information in the collection database illustrated in FIG. 2C. In this case, the apparatus controller may cause the recording part of the apparatus to record the image indicating the pre-participation reward, based on the information stored in the apparatus memory.

In the above-described embodiments, with respect to the cartridge ID as an example of the information unique to the consumable part, the cartridge memory CM stores the cartridge ID, and the printer controller 201 reads the cartridge ID from the cartridge memory CM. The present disclosure, however, is not limited to this. For example, an image indicating the cartridge ID may be recorded on a surface of the casing of the ink cartridge C, and the printer controller 201 may read the image via, for example, a reading part.

In the above-described embodiments, regarding the date (D3) on which the user has been awarded the recycle point in accordance with the ink cartridge C collected before participating in the point-awarding service, “year, month, date” when the recycle point has been awarded is indicated. However, the date (D3) on which the user has been awarded the recycle point may be, for example, “year, month” or “year, month, date and time”. Further, the date (D3) on which the user has been awarded the recycle point may be a specific point in time associated with the collection date or the date on which the user is awarded the reward, and may be, for example, one day after the collection date or the date on which the user is awarded the reward.

The image recording apparatus and the consuming apparatus are not limited to the printer of the ink-jet system. For example, the image recording apparatus and the consuming apparatus may be, for example, a printer of the laser system, or the thermal transfer system. Further, the consuming apparatus is not limited to the image recording apparatus such as a printer, and may also be, for example, a scanner, a conveying apparatus, or another electronic device different from the apparatuses or devices as described above. The electronic device may be, for example, a PC or a smartphone.

The consumable part is not limited to the ink cartridge. For example, in a printer of the laser system, the consumable part may be, for example, a toner cartridge in which toner is stored, or a drum. The consumable part may also be, for example, a cutter, a roller, or a waste liquid tank included in the printer. In the conveying apparatus, the consumable part may be, for example, a roller which conveys a medium. In the electronic device, the consumable part may be, for example, a battery, or a part or component constructing the electronic device.

The external terminal is not limited to the portable terminal such as the smartphone, and may also be, for example, a personal computer. Further, the external terminal may be communicatively connected to the consuming apparatus by wired communication.

The memory may be either a non-volatile memory or a volatile memory.

The medium is not limited to the paper sheet, and may be fabric or plastic film. That is, the medium may be made of any material, provided that an image can be recorded on the medium.

The reward is not limited to the point, and may be, for example, a coupon.

The collected consumable part is not limited to being recycled. For example, the collected consumable part may be reused.

What is claimed is:

1. An image recording apparatus comprising:
a mounting part configured to mount a consumable part detachably;
a recording part configured to consume the consumable part mounted in the mounting part to record an image on a medium; and
an apparatus controller, wherein
the apparatus controller is configured to cause the recording part to record an image indicating a pre-participation reward, as a reward which is awarded to a user in accordance with the consumable part collected before the user participates in a reward-awarding service, the reward being awarded in accordance with collection of the consumable part in the reward-awarding service.

2. The image recording apparatus according to claim 1, wherein
the apparatus controller is configured to cause the recording part to record the image indicating the pre-participation reward before the user participates in the reward-awarding service.

3. The image recording apparatus according to claim 2, wherein
the apparatus controller is configured to cause the recording part to record an image indicating information for participating in the reward-awarding service, together with the image indicating the pre-participation reward, before the user participates in the reward-awarding service.

4. The image recording apparatus according to claim 3, wherein
the information for participating in the reward-awarding service includes a two-dimensional code indicating a URL.

5. The image recording apparatus according to claim 1, wherein
the apparatus controller is configured to cause the recording part to record the image indicating the pre-participation reward after the user has participated in the reward-awarding service.

6. The image recording apparatus according to claim 1, wherein
the apparatus controller is configured to cause the recording part to record an image indicating a specific point in time associated with a collection date of the consumable part collected before participating in the reward-awarding service, or with an awarding date when the reward has been awarded in accordance with the collection of the consumable part, together with the image indicating the pre-participation reward.

7. The image recording apparatus according to claim 1, wherein
the apparatus controller is configured to cause the recording part to record an image indicating information on the consumable part collected before participating in the reward-awarding service, together with the image indicating the pre-participation reward.

8. The image recording apparatus according to claim 1, wherein
the apparatus controller is configured to cause the recording part to record an image indicating a collecting method of the consumable part collected before participating in the reward-awarding service, together with the image indicating the pre-participation reward.

9. The image recording apparatus according to claim 1, wherein
the consumable part collected before participating in the reward-awarding service includes a first consumable part and a second consumable part, and
the apparatus controller is configured to cause the recording part to record an image individually indicating the pre-participation reward for the first consumable part and the pre-participation reward for the second consumable part, together with the image indicating the pre-participation reward.

10. The image recording apparatus according to claim 1, wherein
the apparatus controller is configured to perform a recording process of causing the recording part to record a recording image based on a recording command, and
while the apparatus controller is performing the recording process, the apparatus controller causes the recording part to record the image indicating the pre-participation reward in a margin area as an area, in the medium, other than a recording area in which the recording image is recorded.

11. The image recording apparatus according to claim 10, wherein
the recording image is an image indicating information on the consumable part mounted in the mounting part.

12. The image recording apparatus according to claim 10, wherein
the recording image is an image which is to accompany the consumable part in a case where the consumable part is collected.

13. The image recording apparatus according to claim 10, wherein
the recording image is a test image to confirm recording performed by the recording part.

14. The image recording apparatus according to claim 10, wherein
the recording image is an image with which a function provided by a server communicatively connected to the image recording apparatus is enabled.

15. The image recording apparatus according to claim 1, wherein
the apparatus controller is configured to cause the recording part to record the image indicating the pre-participation reward in a case where the image recording apparatus is communicatively connected to a server including a server memory which stores pre-participation reward information on the pre-participation reward.

16. The image recording apparatus according to claim 1, wherein
the apparatus controller is configured to cause the recording part to record the image indicating the pre-participation reward in a case where the consumable part is detached from the mounting part.

17. The image recording apparatus according to claim 16, wherein
the consumable part is a main tank configured to store a recording material with which an image is to be recorded, and
the image recording apparatus further comprising a sub-tank configured to communicate with the main tank and to store the recording material supplied from the main tank.

18. The image recording apparatus according to claim 1, wherein
the pre-participation reward includes a benefit obtained in a case where the user participates in the reward-awarding service and uses the reward.

19. The image recording apparatus according claim 1, wherein
the apparatus controller causes the recording part to record the image indicating the pre-participation reward in a case where the pre-participation reward satisfies a predetermined condition.

20. An image recording apparatus comprising:
a mounting part configured so that a consumable part is detachably mounted in the mounting part;
a recording part configured to consume the consumable part mounted in the mounting part so as to record an image on a medium; and
an apparatus controller, wherein
the apparatus controller is configured to generate recordable data of an image indicating a pre-participation reward, as a reward which is awarded to a user in accordance with the consumable part collected before the user participates in a reward-awarding service, the reward being awarded in accordance with collection of the consumable part in the reward-awarding service.

21. An external terminal communicatively connected to a consuming apparatus configured so that a consumable part is detachably mounted in the consuming apparatus, the external terminal comprising a terminal controller, wherein
the terminal controller is configured to generate recordable data of an image indicating a pre-participation reward, as a reward which is awarded to a user, associated with the consuming apparatus, in accordance with the consumable part collected before the user participates in a reward-awarding service, the reward being awarded in accordance with collection of the consumable part in the reward-awarding service.

22. A server communicatively connected to a consuming apparatus configured so that a consumable part is detachably mounted in the consuming apparatus, the server comprising a server controller, wherein
the server controller is configured to generate recordable data of an image indicating a pre-participation reward, as a reward which is awarded to a user, associated with the consuming apparatus, in accordance with the consumable part collected before the user participates in a reward-awarding service, the reward being awarded in accordance with collection of the consumable part in the reward-awarding service.
